(19) United States
(12) Patent Application Publication
(10) Pub. No.: US 2018/0163470 A1
(43) Pub. Date: Jun. 14, 2018

(54) Handhold, Ladder and Method

(71) Applicants: Daniel C. Mora, Transfer, PA (US); Robert D. Beggs, Stoneboro, PA (US)

(72) Inventors: Daniel C. Mora, Transfer, PA (US); Robert D. Beggs, Stoneboro, PA (US)

(73) Assignee: Werner Co.

(21) Appl. No.: 15/379,124

(22) Filed: Dec. 14, 2016

(51) Int. Cl. E06C 7/18; E06C 1/06; E06C 7/08

(52) U.S. Cl. CPC E06C 7/183; E06C 7/08; E06C 1/06

(57) ABSTRACT

A ladder includes a first rail. The ladder includes a second rail. The ladder includes a first rung attached to the first and second rails. The ladder includes a second rung attached to the first and second rails. The user climbs the ladder by stepping on the first and second rungs. Each rail having a web with a first flange extending from a first side of the web and a second flange extending from a second side of the web, with the web between the first arid second flange. The first rail having a first handhold extending through the web that a user places the user's hand in to grab the first rail. A method for climbing a ladder. A method for producing a ladder rail. A handhold.

### FIELD OF THE INVENTION

The present invention is related to handholds in a ladder. (As used herein, references to the “present invention” or “invention” relate to exemplary embodiments and not necessarily to every embodiment encompassed by the appended claims.) More specifically, the present invention is related to handholds in a ladder where the handholds are in the rails themselves for a user to comfortably grab while standing on the ladder.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

Whenever a user climbs a ladder, a natural tendency as the user climbs higher on the ladder, is for the user to grab some part of the ladder itself or an object very close to the ladder to provide further support instability to the user. The object that the user typically crabs is the ladder itself, since the ladder is right there upon which the user is standing. When grabbing a ladder rail of the ladder, the ladder rail might be too wide for the user to easily and comfortably grab with their hand. Other objects of either extend from the ladder or are near the ladder, possibly put the user in a somewhat off-balance position that makes the user feel less stable on the ladder. What would be helpful to the user is for the user to be able to grab some part of the ladder itself that the user can more easily grab because the width is smaller and the user can more easily fit their hand around the handhold.

### BRIEF SUMMARY OF THE INVENTION

The present invention pertains to a ladder. The ladder comprises a first rail. The ladder comprises a second rail. The ladder comprises a first rung attached to the first and second rails. The ladder comprises a second rung attached to the first and second rails. The user climbs the ladder by stepping on the first and second rungs. Each rail having a web with a first flange extending from a first side of the web and a second flange extending from a second side of the web, with the web between the first and second flange. The first rail having a first handhold extending through the web that a user places the user's hand in to grab the first rail.

The present invention pertains to a handhold for placement in a hole in a web of a ladder rail. The web disposed between a first flange and a second flange of the rail. The handhold comprises an insert having a perimeter, the insert having. The insert comprises a rim portion that extends from the perimeter and is positioned about the perimeter. The insert comprises a snap portion that extends from the perimeter and fits over an outer face of the web, with the web disposed between the rim portion and the snap portion and in a channel defined by and between the rim portion and the snap portion. The first flange has an outer free end and the insert has a first insert side where the rim portion has an extended rise with a somewhat curved outer surface that extends adjacent to the outer free end of the first flange to provide a comfortable contour for a user to grab without any sharp angled edges that could cut or scratch or injure the user's hand when the handhold is grabbed by the user. The rim portion has a somewhat curved outer surface so as not to injure the user's hand. The snap portion has a plurality of snaps defining the channel with the rim portion through which the insert snaps into the hole.

The present invention pertains to a method for climbing a ladder. The method comprises the steps of climbing a ladder by a user. There is the step of grabbing a first handhold disposed in a first rail of the ladder by placing fingers of a hand through an opening in the handhold in the first rail.

The present invention pertains to a method for producing a ladder rail. The method comprises the steps of creating a hole in a web of the rail. There is the step of snapping a first insert into the hole to form a handhold in the rail for a user to hold the rail.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 shows a perspective view of a ladder of the present invention.

FIG. 2 is a side view of a handhold in a rail.

FIG. 3 shows a cross-sectional view of a handhold in a rail.

FIG. 4 is a perspective overhead view of an insert.

FIG. 5 is a perspective underside view of the insert.

FIG. 6 is a side view of the insert.

FIG. 7 is a side view of the insert.

FIG. 8 is an overhead view of the insert.

FIG. 9 is a side view of the insert.

FIG. 10 is an underside view of the insert.

### DETAILED DESCRIPTION OF THE INVENTION

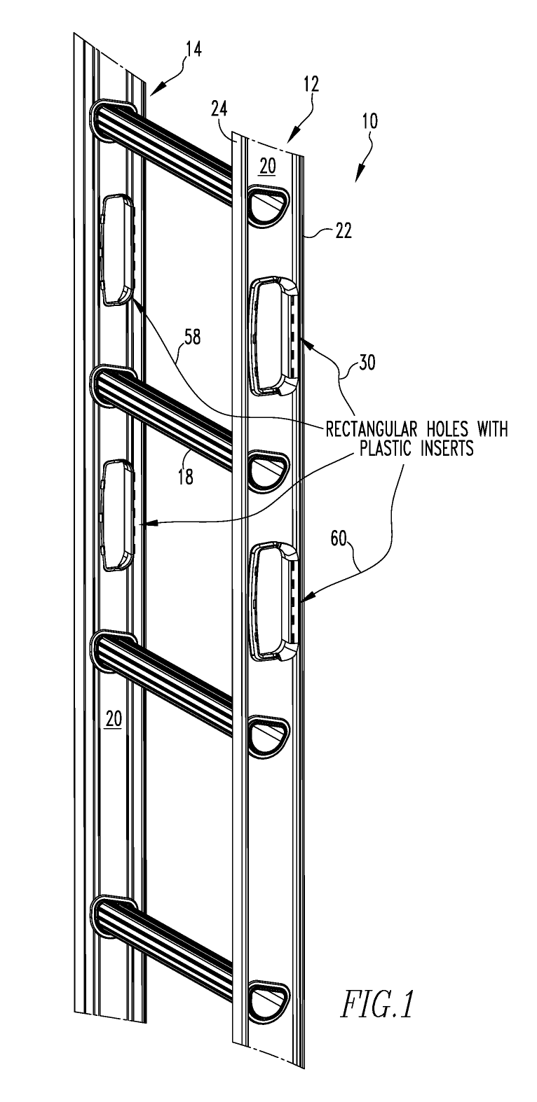

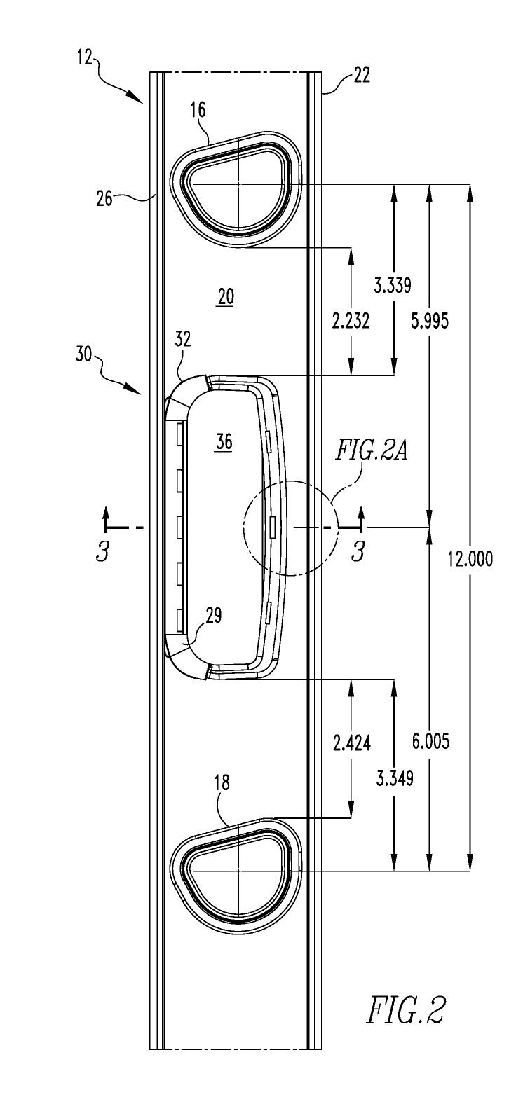

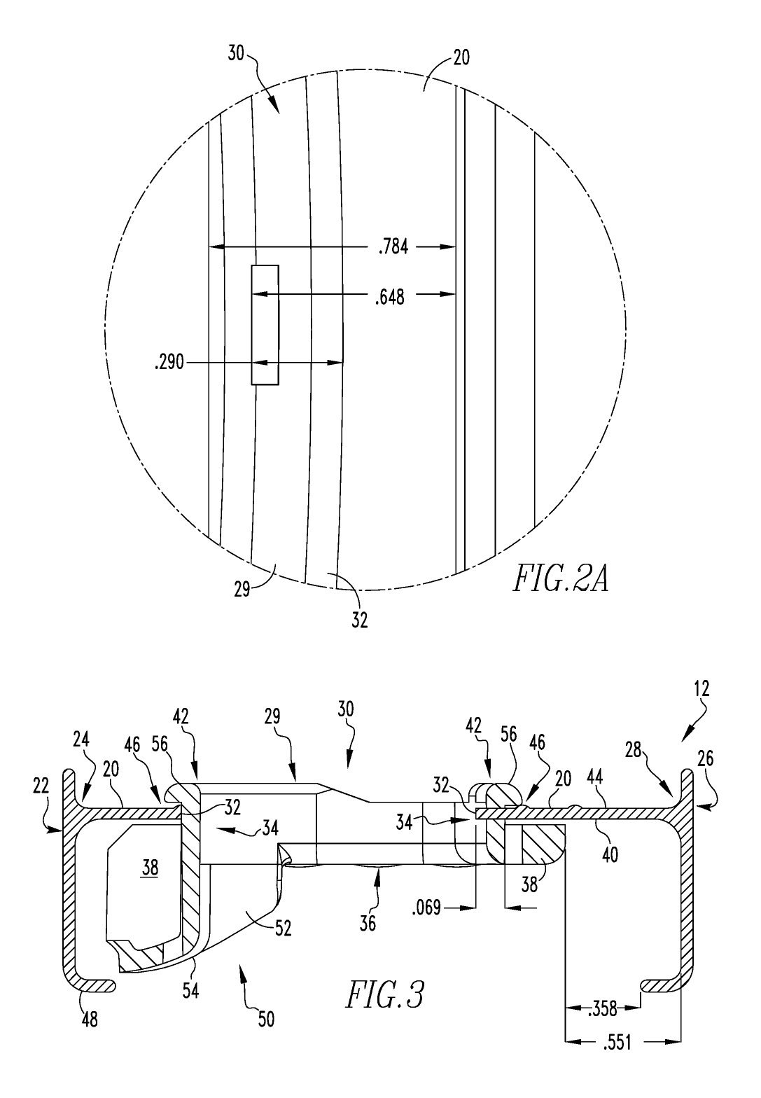

Referring now to the drawings wherein like reference numerals refer to similar or identical parts throughout the several views, and more specifically to FIGS. 1 and 2 thereof, there is shown a ladder 10. The ladder 10 comprises a first rail 12. The ladder 10 comprises a second rail 14, The ladder 10 comprises a first rung 16 attached to the first and second rails 12, 14. The ladder 10 comprises a second rung 18 attached to the first and second rails 12, 14. The user climbs the ladder 10 by stepping on the first and second rungs 16, 18. Each rail having a web 20 with a first flange 22 extending from a first side 24 of the web 20 and a second flange 26 extending from a second side 28 of the web 20, with the web 20 between the first and second flange 26, as shown in FIG. 3. The first rail 12 having a first handhold 30 extending through the web 20 that a user places the users hand in to grab the first rail 12. The first handhold 30 provides the user the ability to grab some part of the ladder 10 itself that the user can more easily grab because the width is smaller than the rail itself and the user can more easily fit their hand around the handhold.

The first rail 12 may have a first hole, and a first insert 29 disposed in the first hole 32 to form the first handhold 30. The hole may be rectangularity shaped. The first insert 29 may be plastic and has a perimeter 34 which conforms with the first hole 32 and an opening 36 in which the user's hand can be placed to grab the first rail 12. The first, insert 29 may snap into the first hole 32 of the first rail 12. The first handhold 30 may be disposed between where the first rung 16 and the second rung 18 are attached to the first rail 12. The first rail 12 may the aluminum.

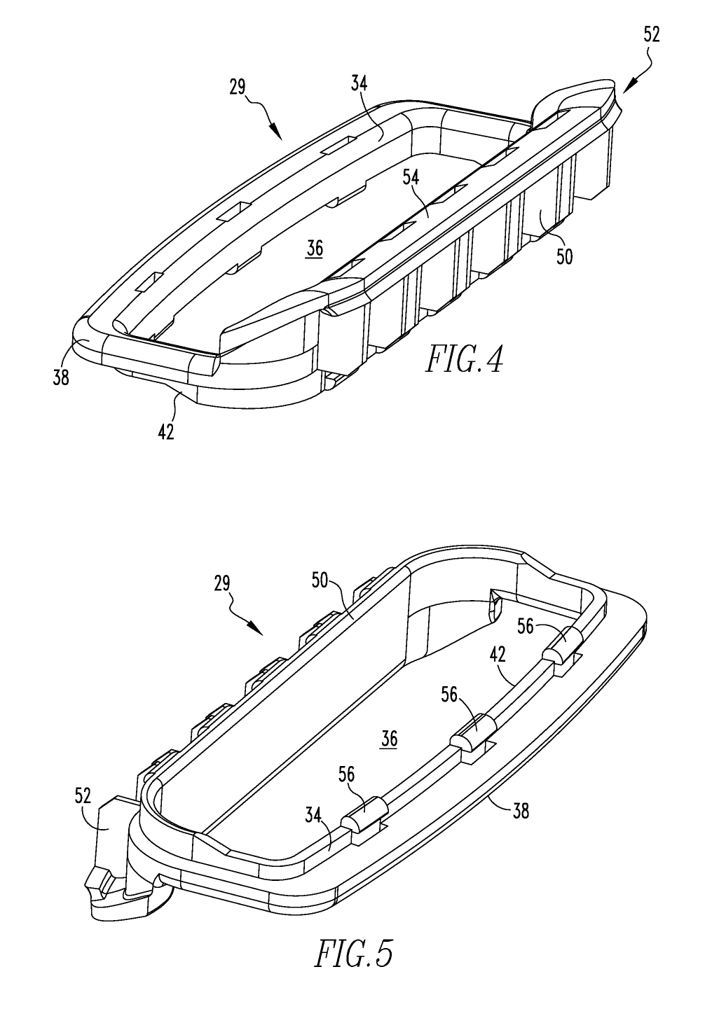

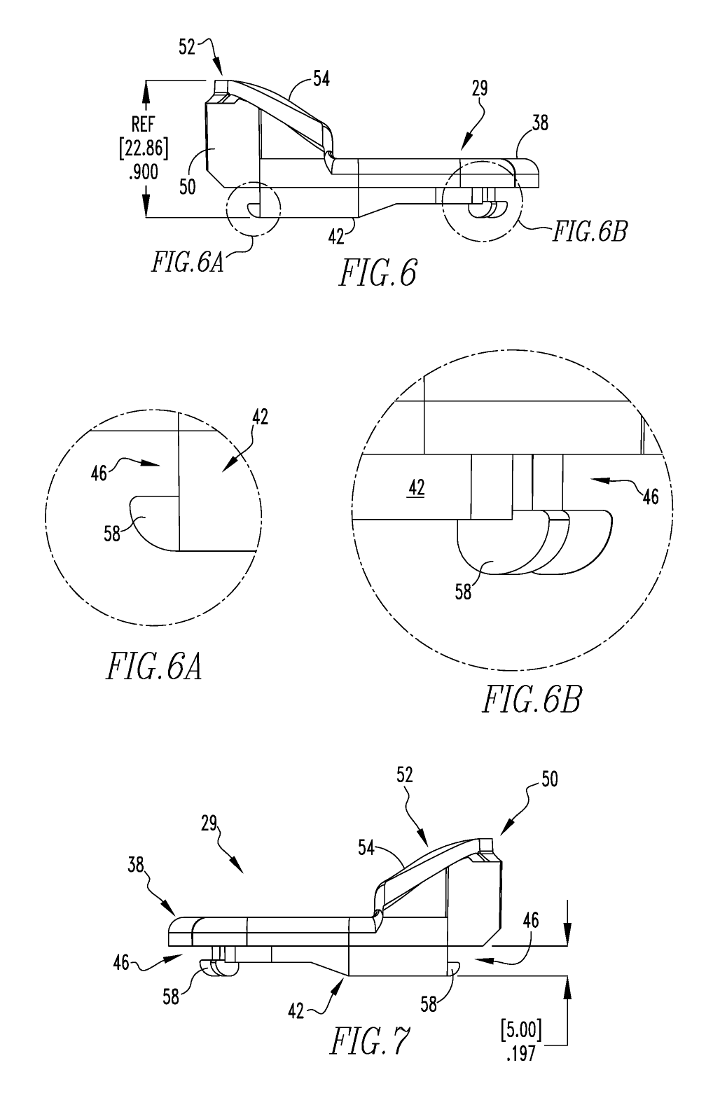

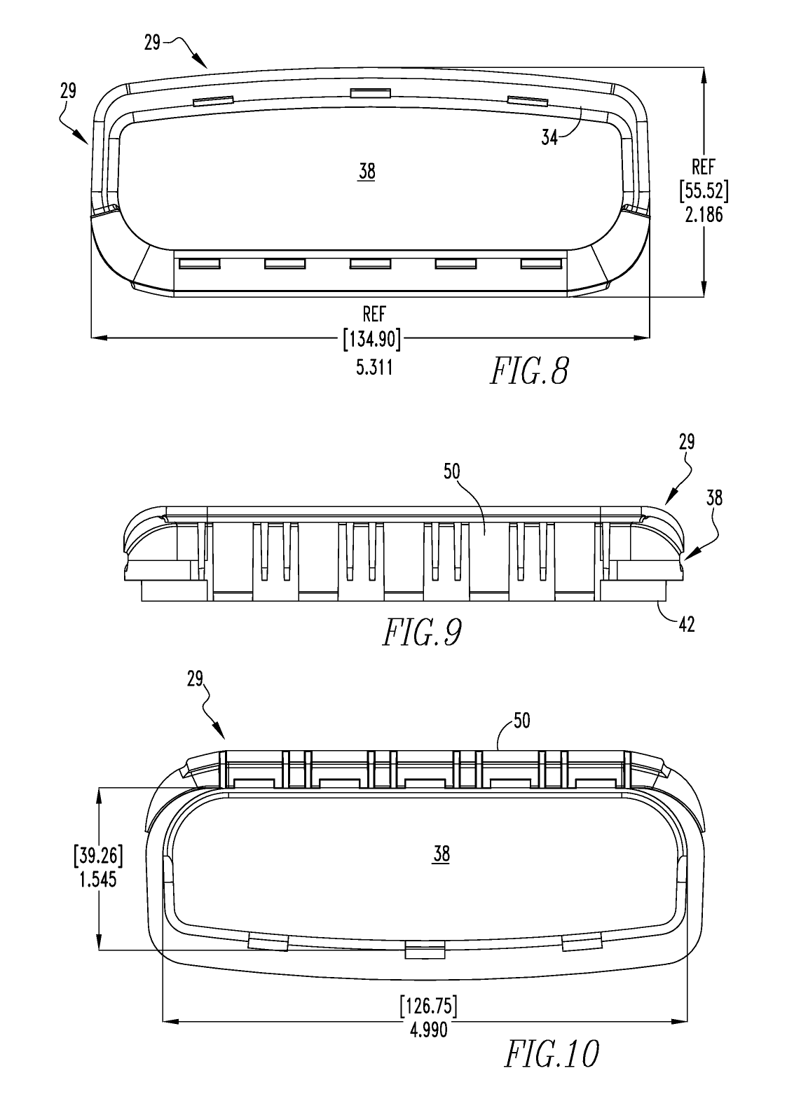

With reference to FIGS. 4 through 10, the first insert 29 may have a rim portion 38 that extends from the perimeter 34 and is positioned about the perimeter 34 and fits over an inner face 40 of the web 20. The first insert 29 may have a snap portion 42 that extends from the perimeter 34 and fits over an outer face 44 of the web 20, with the web 20 disposed between the rim portion 38 and the snap portion 42 and in a channel 46 defined by and between the rim portion 38 and the snap portion 42.

The first flange 22 may have an outer free end 48 and the first insert has a first insert side 50 where the rim portion 38 has an extended rise 52 with a somewhat curved outer surface 54 that extends adjacent to the outer free end 48 of the first flange 22 to provide a comfortable contour for the user to grab without any sharp angled edges that could cut or scratch or injure the user's hand when the first handhold 30 is grabbed by the user. The rim portion 38 may have a somewhat curved outer surface 54 so as not to injure the user's hand. The snap portion 42 may have a plurality of snaps 56 defining the channel 46 with the rim portion 38 through which the first insert snaps 56 into the first hole 32.

The second rail 14 may have a second handhold 58. as shown in FIG. 1. The second handhold 58 may be in alignment with the first handhold 30. The first rail 12 may have a third handhold 60.

The present invention pertains to a handhold 30 for placement in a hole 32 in a web 20 of a ladder rail 12. The web 20 is disposed between a first flange 22 and a second flange 26 of the rail 12. The handhold 30 comprises an insert 29 having a perimeter 34. The insert 29 comprises a rim portion 38 that extends from the perimeter 34 and is positioned about the perimeter 34. The insert 29 comprises a snap portion 42 that extends from the perimeter 34 and fits over an outer face 44 of the web 20, with the web 20 disposed between the rim portion 38 and the snap portion 42 and in a channel 46 defined by and between the rim portion 38 and the snap portion 42. The first flange 22 has an outer free end 48 and the insert 29 has a first insert side 50 where the rim portion 38 has an extended rise 52 with a somewhat curved outer surface 54 that extends adjacent to the outer free end 48 of the first flange 22 to provide a comfortable contour tor a user to grab without any sharp angled edges that could cut or scratch or injure the user's hand when the handhold 30 is grabbed by the user. The rim portion 38 has a somewhat curved outer surface so as not to injure the user's hand. The snap portion 42 has a plurality of snaps 56 defining the channel 46 with the rim portion 38 through which the insert 29 snaps into the first hole 32.

The present invention pertains to a method for climbing a ladder 10. The method comprises the steps of climbing a ladder 10 by a user. There is the step of grabbing a first handhold 30 disposed in a first rail 12 of the ladder 10 by placing lingers of a hand through an opening 36 in the handhold in the first rail 12.

The grabbing step may include the step of grabbing an extended rise 52 of a rim portion 38 of the handhold and in outer free end 48 of a first flange 22 of the first rail 12 which is positioned adjacent the extended rise 52. The extended rise 52 has a somewhat curved surface which essentially aligns with the outer free end 48 of the first flange 22 so when the hand of the user grabs the handhold, the surface of the rise 52 aligning with the outer free end 48 provides for a comfortable grip for the user to wrap the user's fingers around the handhold and the free end of the first flange 22.

The present invention pertains to a method for producing a ladder 10 rail. The method comprises the steps of creating a hole in a web 20 of the rail. There is the step of snapping a first insert into the hole to form a handhold in the rail for a user to hold the rail.

A large press generating over 60 tons of forces is used in order to pierce the aluminum rail and creates the holes in the rail for the insert. The first insert is positioned over the first hole 32 for placement into the first hole 32, and then pushed down into the first hole 32. It is the first insert is pushed into the hole, the snapping portion leads with the individual snaps 56 of the snapping portion having cam surfaces. As the snaps 56 press against the edge of the first hole 32, the edge compresses the snaps 56 and slide along the cam surface as the first insert is pushed into the first hole 32. As the first insert moves down, the edge clears the cam surface and the snap clears the edge so the edge is now in the channel 46 formed between, the snaps 56 and the rim portion 38. The edge has a very tight fit in the channel 46 between the snaps 56, so there is essentially no movement of the first insert once it is in position with the edge of the first bole 32.

The ladder 10 was tested to failure and yielded at 1654 lbs. The ANSI requirement is for a ladder 10 to not feel below 900 lbs., thus the ladder 10 did not fail below 900 lbs. and meets ANSI requirements. The ladder 10 yielded normally without deformation near the rail cut-outs. The rail cut-outs do not show any impact or affect to the ladder 10 rail's structural integrity.

As an example of a preferred embodiment of the invention, as used with the testing; the rail is about 3 inches wide, the first insert is between 4 and 7 inches long, and preferably about 5 inches long; the first insert is between one point 75 inches in 2 point 5 inches wide and preferably about 2 inches wide the height of the first insert from the snap portion 42 to the top of the extended rise 52 is about 1 inch; the distance between the first insert and the first rung 16 or the second run is about 2 to 2.5 inches; distance between the edge of the first insert in the outer edge of the web 20 is about 0.8 inches; the width of the rim portion 38 is about 0.25 inches.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1: A ladder comprising:
a first rail;
a second rail;
a first rung attached to the first and second rails; and
a second rung attached to the first and second rails, a user climbs the ladder by stepping on the first and second rungs, each rail having a web with a first flange extending from a first side of the web and a second flange extending from a second side of the web, with the web between the first and second flange, the first rail having a first handhold extending through the web that a user places the user's hand in to grab the first rail.

2: The ladder of claim 1 wherein the first rail has a first hole, and the first insert disposed in the first hole to form the first handhold.

3: The ladder as described in claim 2 wherein the first hole is rectangular shaped.

4: The ladder of claim 3 wherein the insert is plastic and has a perimeter which conforms to the first hole and an opening in which the user's hand can be placed to grab the first rail.

5: The ladder of claim 4 wherein the first insert snaps into the first hole of the first rail.

6: The ladder of claim 5 wherein the first handhold is disposed between where the first rung and the second rung are attached to the first rail.

7: The ladder of claim 6 wherein the first rail is aluminum.

8: The ladder of claim 7 wherein the first insert has a rim portion that extends from the perimeter and is positioned about the perimeter and fits over an inner face of the web.

9: The ladder of claim 8 wherein the first insert has a snap portion that extends from the perimeter and fits over an outer face of the web, with the web disposed between the rim portion and the snap portion and in a channel defined by and between the rim portion and the snap portion.

10: The ladder of claim 9 wherein the first flange has an outer free end and the first insert has a first insert side where the rim portion has an extended rise with a somewhat curved outer surface that extends adjacent to the outer free end of the first flange to provide a comfortable contour for the user to grab without any sharp angled edges that could cut or scratch or injure the user's hand when the first handhold is grabbed by the user, the rim portion has a somewhat curved outer surface so as not to injure the user's hand.

11: The ladder of claim 10 wherein the snap portion has a plurality of snaps defining the channel with the rim portion through which the first insert snaps into the first hole.

12: The ladder of claim 11 wherein the second rail has a second handhold.

13: The ladder of claim 12 wherein the second handhold is in alignment with the first handhold.

14: The ladder of claim 13 wherein the first rail has a third handhold.

15-18. (canceled)
